(19) United States
(12) Patent Application Publication
(10) Pub. No.: US 2011/0160330 A1
(43) Pub. Date: Jun. 30, 2011

(54) SILSESQUIOXANE COMPOUND HAVING A POLYMERIZABLE FUNCTIONAL GROUP

(76) Inventors: Akinori Nagai, Kanagawa (JP); Masami Kobata, Kanagawa (JP); Osamu Isozaki, Kanagawa (JP)

(21) Appl. No.: 13/060,920

(22) PCT Filed: Aug. 12, 2009
(86) PCT No.: PCT/JP2009/064224

§ 371 Date: Feb. 25, 2011

(30) Foreign Application Priority Data
Aug. 26, 2008 (JP) 2008-217171

(51) Int. Cl. C08F 2/46; C07F 7/21

(52) U.S. Cl. 522/167; 556/439; 522/172; 522/168

(57) ABSTRACT

An object of the present invention is to provide a silsesquioxane compound that is capable of producing a coating film with excellent heat resistance and scratch resistance, and that has excellent compatibility with general polymerizable unsaturated compounds as well as polymerizable unsaturated compounds with high polarity.

The present invention provides a silsesquioxane compound comprising organic groups each directly bonded to a silicon atom of the compound, at least one of the organic groups being an organic group having one or more secondary hydroxyl groups and one (meth)acryloyloxy group.

### TECHNICAL FIELD

The present invention relates to a silsesquioxane compound having a polymerizable functional group, and an active energy ray-curable composition comprising the compound.

### BACKGROUND ART

Silsesquioxane represented by the formula (RSiO_{3/2})ₙ is a general term for a series of network-like polysiloxanes with a ladder, cage, or three-dimensional network (random) structure. Unlike silica, which is a complete inorganic material represented by the formula SiO₂, silsesquioxane is soluble in general organic solvents; therefore, it is easy to handle, and processability and moldability during membrane formation etc. are excellent.

On the other hand, as an unsaturated compound having radical polymerization properties, polyfunctional acrylate, unsaturated polyester, etc., are widely investigated, and are industrially used. Various studies are conducted on such radical-polymerizable unsaturated compounds for the purpose of providing scratch resistance, stain resistance, etc., with their cured products. However, a composition obtained by mixing an organopolysiloxane compound, such as silsesquioxane, with a widely used radical-polymerizable unsaturated compound has disadvantages such that a uniform composition is hard to produce because of its poor compatibility, and that an organopolysiloxane compound is separated from the resulting cured product.

Patent Documents 1 to 5 disclose inventions relating to silsesquioxane having a radical-polymerizable functional group such as an acryloyloxy or methacryloyloxy group, and an ultraviolet curable composition containing the silsesquioxane. Such silsesquioxane-containing compositions have excellent heat resistance and scratch resistance; however, silsesquioxane has a problem such that its compatibility with other polymerizable unsaturated compounds, in particular, with polymerizable unsaturated compounds having high polarity is insufficient.

### CITATION LIST

### Patent Literature

PTL 1: Japanese Unexamined Patent Publication No. H3-281616

PTL 2: Japanese Unexamined Patent Publication No. H4-28722

PTL 3: Japanese Unexamined Patent Publication No. 2002-167552

PTL 4: Japanese Unexamined Patent Publication No. 2002-363414

PTL 5: WO04/85501

### SUMMARY OF INVENTION

### Technical Problem

The present invention was made in light of the aforementioned circumstances. An object of the present invention is to provide a silsesquioxane compound that is capable of producing a coating film with excellent heat resistance and scratch resistance, and that has excellent compatibility with general polymerizable unsaturated compounds as well as polymerizable unsaturated compounds with high polarity.

### Solution to Problem

The present inventors conducted extensive research to solve the above problems; consequently, they found that the aforementioned problems can be solved by introducing as an organic group directly bonded to a silicon atom, an organic group having one or more secondary hydroxyl groups and one (meth)acryloyloxy group into a silsesquioxane compound. The present invention was thus accomplished.

Specifically, the present invention is as follows:
Item 1. A silsesquioxane compound comprising organic groups each directly bonded to a silicon atom of the compound, at least one of the organic groups being an organic group having one or more secondary hydroxyl groups and one (meth)acryloyloxy group.
Item 2. The silsesquioxane compound according to Item 1 represented by the formula (I):

(R¹SiO_{3/2})ₘ(R²SiO_{3/2})ₙ(R³SiO_{3/2})ₚ (I)

wherein R¹ is an organic group having one or more secondary hydroxyl groups and one (meth)acryloyloxy group; R² is an organic group having an epoxy group; R³ is a hydrogen atom, a C₁₋₃₀ substituted or unsubstituted monovalent hydrocarbon group, an organic group having a vinyl group, or a (meth)acryloyloxy alkyl group in which the alkyl group has 1 to 3 carbon atoms; each of R¹, R², and R³ may be the same or different; m is an integer of 1 or more; n is an integer of 0 or more; p is an integer of 0 or more; and m +n +p is an integer of 4 or more.
Item 3. The silsesquioxane compound according to Item 1 or 2, which has a weight average molecular weight of 1,000 to 100,000.
Item 4. The silsesquioxane compound according to Item 2 or 3, wherein in the formula (I), 12¹ is an organic group represented by the formula (II) or (III):

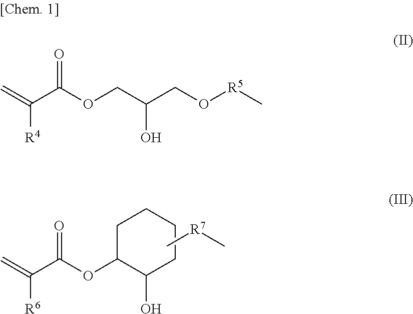

in the formula (II), R⁴ is a hydrogen atom or a methyl group, and R⁵ is a C₁₋₁₀ divalent hydrocarbon group; in the formula (III), R⁶ is a hydrogen atom or a methyl group, and R⁷ is a C₁₋₁₀ divalent hydrocarbon group.
Item 5. An active energy ray-curable composition comprising the silsesquioxane compound according to any one of Items 1 to 4, and a photoinitiator.
Item 6. The active energy ray-curable composition according to Item 5, further comprising a polymerizable unsaturated compound.
Item 7. The active energy ray-curable composition according to Item 6, wherein the polymerizable unsaturated compound is selected from the group consisting of an esterified product of an monohydric alcohol and (meth)acrylic acid, an esterified product of a polyhydric alcohol and (meth)acrylic acid, a urethane (meth)acrylate resin, an epoxy (meth)acrylate resin, and a polyester (meth)acrylate resin.
Item 8. The active energy ray-curable composition according to Item 6, wherein the esterified product of a monohydric alcohol and (meth)acrylic acid is selected from the group consisting of methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, neopentyl(meth)acrylate, cyclohexyl(meth)acrylate, tetrahydrofurfuryl(meth)acrylate, isobornyl(meth)acrylate, phenyl(meth)acrylate, benzyl(meth)acrylate, and N-acryloyloxyethyl hexahydrophthalimide; and

the esterified product of a polyhydric alcohol and (meth)acrylic acid is selected from the group consisting of di(meth)acrylate compounds such as ethylene glycol di(meth)acrylate, diethylene glycol di(meth)acrylate, triethylene glycol di(meth)acrylate, tetraethylene glycol di(meth)acrylate, 1,3-butanediol di(meth)acrylate, 1,4-butanediol di(meth)acrylate, 1,9-nonanediol di(meth)acrylate, glycerin di(meth)acrylate, trimethylolpropane di(meth)acrylate, pentaerythritol di(meth)acrylate, neopentyl glycol di(meth)acrylate, 1,6-hexanediol di(meth)acrylate, pentaerythritol di(meth)acrylate, and bisphenol A ethylene oxide-modified di(meth)acrylate; tri(meth)acrylate compounds such as glycerin tri(meth)acrylate, trimethylolpropane tri(meth)acrylate, trimethylolpropane propylene oxide-modified tri(meth)acrylate, trimethylolpropane ethylene oxide-modified tri(meth)acrylate, pentaerythritol tri(meth)acrylate, and ε-caprolactone-modified tris(acryloxyethyl) isocyanurate; tetra(meth)acrylate compounds such as pentaerythritol tetra(meth)acrylate; dipentaerythritol penta(meth)acrylate, and dipentaerythritol hexa(meth)acrylate.

### Advantageous Effects of Invention

The silsesquioxane compound of the present invention can produce a silsesquioxane compound having excellent compatibility with a general polymerizable unsaturated compound as well as excellent compatibility with a polymerizable unsaturated compound having high polarity, by introducing as an organic group directly bonded to a silicon atom, an organic group having one or more secondary hydroxyl groups and one (meth)acryloyloxy group into a silsesquioxane compound. Further, because of its excellent compatibility with various polymerizable unsaturated compounds, the silsesquioxane compound of the present invention can be used in various active energy ray-curable compositions, and can improve the heat resistance and scratch resistance of coating films that are obtained from the active energy ray-curable compositions.

### BRIEF DESCRIPTION OF DRAWINGS

FIG. 1 shows examples of a rudder structure, a cage structure, and a random structure. In FIG. 1, each R represents an organic group directly bonded to a silicon atom.

### DESCRIPTION OF EMBODIMENTS

The silsesquioxane compound of the present invention is a silsesquioxane compound comprising organic groups each directly bonded to a silicon atom, wherein at least one of the organic groups is an organic group having one or more secondary hydroxyl groups and one (meth)acryloyloxy group (hereinafter, sometimes simply referred to as “the silsesquioxane compound of the present invention”). Since at least one of the organic groups each directly bonded to a silicon atom of the silsesquioxane compound of the present invention is an organic group having one or more secondary hydroxyl groups and one (meth)acryloyloxy group, the silsesquioxane compound has excellent compatibility with various polymerizable unsaturated compounds because of the polarity of the secondary hydroxyl group that is included in the organic group, and the silsesquioxane compound can be cured by active energy ray irradiation conducted in the presence of a photoinitiator because of the (meth)acryloyloxy group included in the organic group. For this reason, the silsesquioxane compound of the present invention is useable in various active energy ray-curable compositions.

The organic group having one or more secondary hydroxyl groups and one (meth)acryloyloxy group can be obtained, for example, by reacting (meth)acrylic acid with an organic group having an epoxy group. In this reaction, one epoxy group produces one secondary hydroxyl group and one (meth)acryloyloxy group.

### Silsesquioxane Compound of the Present Invention

The silsesquioxane compound of the present invention has organic groups each directly bonded to a silicon atom via Si—C bonds, in which at least one of the organic group is an organic group having one or more secondary hydroxyl groups and one (meth)acryloyloxy group.

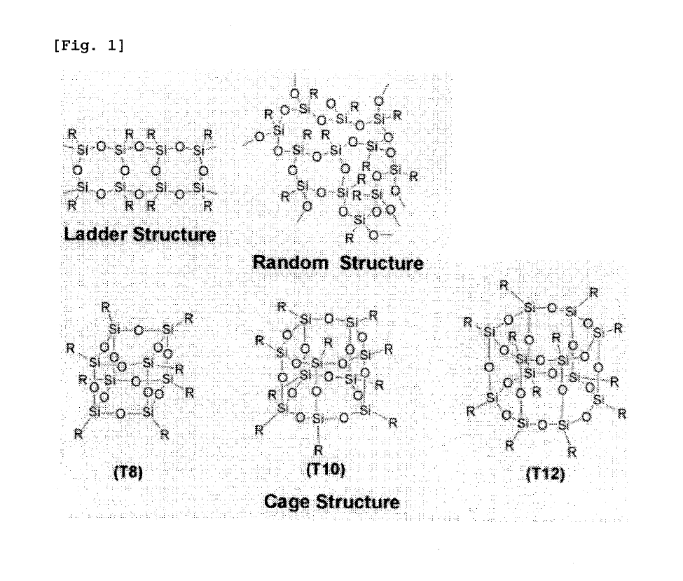

The term “silsesquioxane compound” used herein indicates not only a silsesquioxane compound having a structure in which all of the Si—OH groups (hydroxysilyl groups) are hydrolyzed and condensed, but also silsesquioxane compounds having a random structure, an incomplete cage structure, or a rudder structure in which Si—OH groups remain. FIG. 1 shows examples of the rudder structure, cage structure, and random structure. In FIG. 1, (T8) denotes a cage structure composed of eight T units, (T10) denotes a cage structure composed of ten T units, and (T12) denotes a cage structure composed of 12 T units.

In the silsesquioxane compound of the present invention, the proportion of the silsesquioxane compound having a structure in which all of the Si—OH groups are hydrolyzed and condensed is preferably 80 mass % or more, more preferably 90 mass % or more, and even more preferably 100 mass % in terms of liquid stability.

An example of the silsesquioxane compound of the present invention is represented by the formula (I):

(R¹SiO_{3/2})ₘ(R²SiO_{3/2})ₙ(R³SiO_{3/2})ₚ (I)

In the formula (I), R¹ is an organic group having one or more secondary hydroxyl groups and one (meth)acryloyloxy group; R² is an organic group having an epoxy group; and R³ is a hydrogen atom, a C₁₋₃₀ substituted or unsubstituted monovalent hydrocarbon group, an organic group having a vinyl group, or a (meth)acryloyloxy alkyl group (the carbon number of the alkyl group is 1 to 3). R¹, R², and R³ may be the same or different from each other. m is an integer of 1 or more, n is an integer of 0 or more, p is an integer of 0 or more, and m+n+p is an integer of 4 or more.

Specific examples of R¹ in the formula (I) include organic groups represented by the formula (II) or (III):

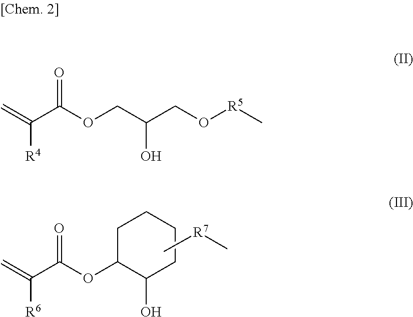

In the formula (II), R⁴ is a hydrogen atom or a methyl group, and R⁵ is a C₁₋₁₀ divalent hydrocarbon group. In the formula (III), R⁶ is a hydrogen atom or a methyl group, and R⁷ is a C₁₋₁₀ divalent hydrocarbon group.

Any C₁₋₁₀ divalent hydrocarbon group can be used as R⁵ in the formula (II) without limitation. Specific examples thereof include alkylene groups such as methylene, ethylene, 1,2-propylene, 1,3-propylene, 1,2-butylene, 1,4-butylene, and hexylene; cycloalkylene groups such as cyclohexylene; arylene groups such as phenylene, xylylene, and biphenylene; and the like. Among these, C₁₋₆ divalent hydrocarbon groups (e.g., alkylene), particularly ethylene (—CH₂CH₂—) and 1,3-propylene (—CH₂CH₂CH₂—), are preferred because they have superior heat resistance, scratch resistance, and compatibility with polymerizable unsaturated compounds having high polarity.

Any C₁₋₁₀ divalent hydrocarbon group can be used as R⁷ in the formula (III) without limitation. Specific examples thereof are the same as the aforementioned divalent hydrocarbon groups described as specific examples of R⁵. Among these, C₁₋₆ divalent hydrocarbon groups (e.g., alkylene), and particularly ethylene (—CH₂CH₂—) and 1,3-propylene (—CH₂CH₂CH₂—), are preferred because they have superior heat resistance, scratch resistance, and compatibility with polymerizable unsaturated compounds having high polarity.

R¹ in the formula (I) is preferably an organic group represented by the formula (II) wherein R⁴ is a hydrogen atom, and R⁵ is a 1,3-propylene group, or an organic group represented by the formula (III) wherein R⁶ is a hydrogen atom, and R⁷ is an ethylene group, because these organic groups have superior heat resistance, scratch resistance, compatibility with polymerizable unsaturated compounds having high polarity, and active energy-ray curability.

Any organic group having an epoxy group can be used as R² in the formula (I) without limitation. Specific examples thereof include 2,3-epoxypropyl, 3-glycidoxypropyl, 2-(3,4-epoxycyclohexyl)ethyl, and like groups.

Any of a hydrogen atom, a C₁₋₃₀ substituted or unsubstituted monovalent hydrocarbon group, an organic group having a vinyl group, and a (meth)acryloyloxyalkyl group (the carbon number of the alkyl group is 1 to 3) can be used as R³ in the formula (I) without limitation.

Specific examples of the C₁₋₃₀ substituted or unsubstituted monovalent hydrocarbon group of R³ in the formula (I) include non-cyclic or cyclic aliphatic monovalent hydrocarbon groups such as methyl, ethyl, n-propyl, isopropyl, n-butyl, isobutyl, tert-butyl, sec-butyl, n-pentyl, isopentyl, neopentyl, cyclopentyl, n-hexyl, isohexyl, cyclohexyl, n-heptyl, isoheptyl, n-octyl, isooctyl, tert-octyl, n-nonyl, isononyl, n-decyl, isodecyl, n-undecyl, isoundecyl, n-dodecyl, isododecyl, and other linear or branched alkyl groups; aralkyl groups such as benzyl, phenethyl, 2-methylbenzyl, 3-methylbenzyl, and 4-methylbenzyl; aryl groups such as aralkenyl, phenyl, tolyl, and xylyl; fluorine-containing alkyl groups such as 3,3,3-trifluoro-n-propyl; and the like. Particularly, in terms of superior compatibility with polymerizable unsaturated compounds having high polarity, C₁₋₆ substituted or unsubstituted monovalent hydrocarbon groups are preferred; and methyl, ethyl, isobutyl, cyclopentyl, cyclohexyl, phenyl, and 3-trifluoropropyl groups are even more preferred.

A specific example of the organic group having a vinyl group used as R³ in the formula (I) is an allyl group.

Specific examples of the (meth)acryloyloxyalkyl group used as R³ in the formula (I) include (meth)acryloyloxymethyl, 2-(meth)acryloyloxyethyl, 3-(meth)acryloyloxypropyl, and like groups.

In the formula (I), m is an integer of 1 or more, preferably an integer of 2 or more, more preferably an integer of 4 to 100, and even more preferably an integer of 4 to 50; n is an integer of 0 or more, and preferably an integer of 0 to 4; p is an integer of 0 or more, and preferably an integer of 0 to 4; and m+n+p is an integer of 4 or more, preferably an integer of 4 to 100, and even more preferably an integer of 4 to 50.

The silsesquioxane compound of the present invention may have a single composition in which m, n, and p are the same as each other, or may be a mixture of a plurality of silsesquioxane compounds in which at least one of m, n, and p is different from the others. For example, such a mixture is prepared by mixing 50 mass % or more, preferably 70 mass % or more, of a silsesquioxane compound of the present invention represented by the formula (I) wherein m+n+p is 8, 10, 12, or 14, with a mixture of silsesquioxane compounds of the present invention having different compositions.

The weight average molecular weight of the silsesquioxane compound of the present invention is not limited, and is preferably 1,000 to 100,000, and more preferably 1,000 to 10,000. These ranges are significant in terms of the heat resistance of coating films obtained from the silsesquioxane compound of the present invention, and the viscosity and application properties of active energy ray-curable compositions comprising the silsesquioxane compound of the present invention.

In the present specification, the weight average molecular weight is a value determined by converting a weight average molecular weight measured by gel permeation chromatography, based on the weight average molecular weight of polystyrene. Specifically, the value is determined by converting a weight average molecular weight measured using a gel permeation chromatograph (“HLC8120GPC”, trade name; a product of Tosoh Corporation), based on the weight average molecular weight of polystyrene. Measurements were performed using four columns “TSKgel G-4000 HXL”, “TSKgel G-3000 HXL”, “TSKgel G-2500 HXL”, and “TSKgel G-2000 HXL” (trade names; products of Tosoh Corporation) under the following conditions: mobile phase: tetrahydrofuran; measurement temperature: 40° C.; flow rate: 1 ml/min.; and detector: RI.

### Production Method of Silsesquioxane Compound of the Present Invention

The production method of the silsesquioxane compound of the present invention is not limited and may be a general method conventionally used in the production of silsesquioxane. In addition, the silsesquioxane compound can also be produced, for example, using the following production method A or B.

### Production Method A

For example, the production method A is carried out using a starting material containing a hydrolyzable silane having an organic group that is directly bonded to a silicon atom and has one ore more secondary hydroxyl groups and one (meth)acryloyloxy group.

Specifically, the silsesquioxane compound of the present invention is produced, for example, by hydrolysis condensation of the starting material using hydrolyzable silanes represented by the following formulae (IV) to (VI) in the presence of a catalyst. R¹SiX₃ is obtainable by reacting R²SiX³ with acrylic acid or methacrylic acid.

R²SiX₃+(CH₂═CH—COOH or CH₂═C(CH₃)—COOH)→R¹SiX₃

(R¹ and R² are as defined above.)

R¹SiX₃ (IV)

R²SiX₃ (V)

R³SiX₃ (VI)

m(R¹SiX₃)+n(R²SiX₃)+p(R³SiX₃)→(R¹SiO_{3/2})ₘ(R²SiO_{3/2})ₙ(R³SiO_{3/2})ₚ (I)

R¹, R², and R³ in the formulae (IV) to (VI) are the same as R¹, R², and R³ in the formula (I), respectively. X is chlorine or a C₁₋₆ alkoxy group, and Xs may be the same or different from each other. Specific examples of X include chlorine, methoxy, ethoxy, propoxy, butoxy, etc.

Specifically, the hydrolyzable silane represented by the formula (IV) is obtainable, for example, by reacting (meth)acrylic acid with an epoxy group-containing trialkoxysilane.

Specific examples of the hydrolyzable silane represented by the formula (IV) include hydrolyzable silanes represented by the formula (VII) or (VIII):

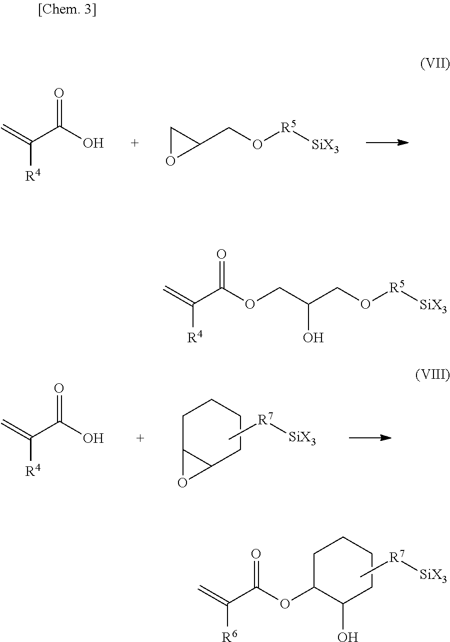

R⁴, R⁵, R⁶, and R⁷ in the formulae (VII) and (VIII) are the same as R⁴, R⁵, R⁶, and R⁷ in the formulae (II) and (III), respectively. Xs are the same as those in the formulae (IV) to (VI), and may be the same or different from each other. Specific examples of X include chlorine, methoxy, ethoxy, propoxy, butoxy, etc.

Specifically, the hydrolyzable silane represented by the formula (VII) or (VIII) is obtainable, for example, by reacting (meth)acrylic acid with at least one of 2,3-epoxypropyltrimethoxysilane, 2,3-epoxypropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, etc.

Using the production method A, the silsesquioxane compound of the present invention is specifically obtained as follows:

[1] The hydrolyzable silane represented by the formula (IV) is used as a starting material, and subjected to hydrolysis condensation in the presence of a catalyst; or

[2] The hydrolyzable silane represented by the formulae (IV), and the hydrolyzable silanes represented by the formulae (V) and/or (VI) are used as starting materials, and subjected to hydrolysis condensation in the presence of a catalyst.

A preferred catalyst is a basic catalyst. Specific examples of basic catalysts include alkali metal hydroxides such as potassium hydroxide, sodium hydroxide, and cesium hydroxide; quaternary ammonium hydroxide salts such as tetramethylammonium hydroxide, tetraethylammonium hydroxide, tetrabutylammonium hydroxide, and benzyltrimethylammonium hydroxide; ammonium fluoride salts such as tetrabutylammonium fluoride; and the like.

The amount of the catalyst used is not limited; however, using a too large amount of the catalyst results in high costs and difficulties in removing the catalyst, while using a too small amount of the catalyst slows the reaction. Therefore, the amount of the catalyst is preferably 0.0001 to 1.0 mol, and more preferably 0.0005 to 0.1 mol, per mol of hydrolyzable silane.

When the hydrolysis condensation reaction is carried out (the above process [1] or [2]), water is used. The proportion of hydrolyzable silane to water is not limited. The amount of water used is preferably 0.1 to 100 mol, and more preferably 0.5 to 3 mol, per mol of hydrolyzable silane. When the amount of water is too low, the reaction proceeds slowly, possibly resulting in a reduced yield of the target silsesquioxane. Conversely, when the amount of water is too high, the molecular weight of the resulting product is increased, possibly resulting in a reduced amount of product having the desired structure.)

Moreover, when a basic catalyst is used in the form of an aqueous solution, the water used in the reaction may be substituted by the solution, or water may be further added.

In the above hydrolysis condensation reaction, an organic solvent may or may not be used. The use of an organic solvent is preferred in terms of preventing gelation and controlling viscosity during production. As the organic solvent, a polar organic solvent and a nonpolar organic solvent may be used alone or as a mixture thereof.

Examples of polar organic solvents include lower alcohols such as methanol, ethanol, and 2-propanol; ketones such as acetone and methyl isobutyl ketone; and ethers such as tetrahydrofuran; particularly, acetone and tetrahydrofuran are preferred because they have a low boiling point, and their use results in a homogeneous system and improved reactivity. Preferred examples of nonpolar organic solvents include hydrocarbon-based solvents; toluene, xylene, and like organic solvents that have a boiling point higher than that of water are more preferred; and toluene and like organic solvents that are azeotroped with water are particularly preferred because water can be efficiently removed from the system. Particularly, a mixture of a polar organic solvent and a nonpolar organic solvent is preferably used because the aforementioned advantages of both solvents can be achieved.

The temperature in the hydrolysis condensation reaction is 0 to 200° C., preferably 10 to 200° C., and more preferably 10 to 120° C. Although this reaction can be carried out at any pressure, the pressure range is preferably 0.02 to 0.2 MPa, and more preferably 0.08 to 0.15 MPa.

In the hydrolysis condensation reaction, the condensation reaction proceeds with the hydrolysis reaction. In terms of liquid stability, it is preferred that most of the Xs in the formulae (IV) to (VI), and preferably 100% of the Xs, are hydrolyzed into hydroxyl (OH) groups, and that most of the OH groups, preferably 80% or higher, more preferably 90% or higher, and even more preferably 100% of the OH groups, are condensed.

After the hydrolysis condensation reaction, the solvent, alcohol produced by the reaction, and catalyst may be removed from the mixture by a known technique. The obtained product may be further purified by removing the catalyst using various purification methods (e.g., washing, column separation, and solid absorbent), depending on the purpose. Preferably, in terms of efficiency, the catalyst is removed by washing with water.

The silsesquioxane compound of the present invention is produced by the above-described production method.

When not all of the OH groups are condensed in the hydrolysis condensation reaction, the product obtained by the production method A may contain, other than the silsesquioxane compound having a structure in which all of the Si—OH (hydroxysilyl) groups have been subjected to hydrolysis condensation, silsesquioxane compounds having a rudder structure, an incomplete cage structure, and/or a random structure, in which the Si—OH groups remain. The silsesquioxane compound of the present invention obtained by the production method A may contain such compounds having a rudder structure, an incomplete cage structure, and/or a random structure.

### Production Method B

For example, the production method B comprises step B1 of producing a silsesquioxane compound having a functional group (a) that can introduce a secondary hydroxyl group and a (meth)acryloyloxy group by reaction with other compounds, by using a hydrolyzable silane having the functional group (a), and step B2 of reacting the functional group (a) of the silsesquioxane compound obtained in step B1, with a compound having a (meth)acryloyloxy group and a functional group (b) that can produce a secondary hydroxyl group by reaction with the functional group (a) of the silsesquioxane compound. Examples of the functional group (a) include epoxy, amino, etc. Examples of the functional group (b) include carboxyl (COOH), epoxy, etc. Examples of the compound having the functional group (b) include (meth)acrylic acid, glycidyl (meth)acrylate, etc. Examples of other combinations of the functional group (a) and the functional group (b) include a combination of epoxy (functional group (a)) and carboxyl (functional group (b)), and a combination of amino (functional group (a)) and epoxy (functional group (b)). The following is an example in which the functional group (a) is epoxy, and the hydrolyzable silane having the functional group (a) is R²SiX3.

### <Step B1>

(m+n)(R²SiX₃)+p(R³SiX₃)→(R²SiO_{3/2})₍ₘ₊ₙ₎(R³SiO_{3/2})ₚ

### <Step B2>

(R²SiO_{3/2})₍ₘ₊ₙ₎(R³SiO_{3/2})ₚ+m{CH₂═C(R⁴)—COOH}→(R¹SiO_{3/2}(ₘ(R²SiO_{3/2})ₙ(R³SiO_{3/2})ₚ

(R¹ to R⁴, m, n, p, and X are as defined above.)

Since step B2 of the production method B is conducted after a silsesquioxane compound is produced, a catalyst, reaction temperature, and other conditions suitable for the reaction in step B2 can be determined without taking hydrolysis condensation of alkoxysilane into consideration in step B2 of the production method B. For this reason, the production time can be reduced in the production method B.

### Step B1

In step B1, specifically, for example, hydrolyzable silanes represented by the following formulae (V) and (VI), which are the same as the formulae (V) and (VI), respectively, described in the production method A, are used as starting materials, and subjected to hydrolysis condensation in the presence of a catalyst, thereby producing a silsesquioxane compound having the functional group (a) that can introduce a secondary hydroxyl group and a (meth)acryloyloxy group.

R²SiX₃ (V)

R³SiX₃ (VI)

The epoxy group of the hydrolyzable silane represented by the formula (V) can be used as the functional group (a) that can introduce a secondary hydroxyl group and a (meth)acryloyloxy group.

Specific examples of the hydrolyzable silane represented by the formula (V) include 2,3-epoxypropyltrimethoxysilane, 2,3-epoxypropyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, and the like.

In step B1, a silsesquioxane compound having the functional group (a) is specifically obtained as follows:

[3] The hydrolyzable silane represented by the formula (V) is used as a starting material, and subjected to hydrolysis condensation in the presence of a catalyst; or

[4] The hydrolyzable silanes represented by the formulae (V) and (VI) are used as starting materials, and subjected to hydrolysis condensation in the presence of a catalyst.

A suitable catalyst is a basic catalyst. Specific examples of basic catalysts include alkali metal hydroxides such as potassium hydroxide, sodium hydroxide, and cesium hydroxide; quaternary ammonium hydroxide salts such as tetramethylammonium hydroxide, tetraethylammonium hydroxide, tetrabutylammonium hydroxide, and benzyltrimethylammonium hydroxide; ammonium fluoride salts such as tetrabutylammonium fluoride; and the like.

The amount of the catalyst used is not limited; however, using a too large amount of the catalyst results in high costs and difficulties in removing the catalyst, while using a too small amount of the catalyst slows the reaction. Therefore, the amount of the catalyst is preferably 0.0001 to 1.0 mol, and more preferably 0.0005 to 0.1 mol, per mol of hydrolyzable silane.

When the hydrolysis condensation reaction is carried out (the above process [3] or [4]), water is used. The proportion of hydrolyzable silane and water is not limited. The amount of water used is preferably 0.1 to 100 mol, and more preferably 0.5 to 3 mol, per mol of hydrolyzable silane. When the amount of water is too low, the reaction proceeds slowly, possibly resulting in a reduced yield of the target silsesquioxane. Conversely, when the amount of water is too high, the molecular weight of the resulting product is increased, possibly resulting in a reduced amount of product having the desired structure. Moreover, when a basic catalyst is used in the form of an aqueous solution, the water used in the reaction may be substituted by the solution, or water may be further added.

In the hydrolysis condensation reaction, an organic solvent may or may not be used. The use of an organic solvent is preferred in terms of preventing gelation and controlling viscosity during production. As the organic solvent, a polar organic solvent and a nonpolar organic solvent may be used alone or as a mixture thereof.

Examples of polar organic solvents include lower alcohols such as methanol, ethanol, and 2-propanol; ketones such as acetone and methyl isobutyl ketone; and ethers such as tetrahydrofuran; particularly, acetone and tetrahydrofuran are preferred because they have a low boiling point, and their use results in a homogeneous system and improved reactivity. Preferred examples of nonpolar organic solvents include hydrocarbon-based solvents; toluene, xylene, and like organic solvents that have a boiling point higher than that of water are more preferred; and toluene and like organic solvents that are azeotroped with water are particularly preferred because water can be efficiently removed from the system. Particularly, a mixture of a polar organic solvent and a nonpolar organic solvent is preferably used because the aforementioned advantages of both solvents can be achieved.

The temperature in the hydrolysis condensation reaction is 0 to 200° C., preferably 10 to 200° C., and more preferably 10 to 120° C. Although this reaction can be carried out at any pressure, the pressure range is preferably 0.02 to 0.2 MPa, and more preferably 0.08 to 0.15 MPa.

In the hydrolysis condensation reaction, the condensation reaction proceeds with the hydrolysis reaction. In terms of liquid stability, it is preferred that most of the Xs in the formulae (V) and (VI), and preferably 100% of the Xs, are hydrolyzed into hydroxyl (OH) groups, and that most of the OH groups, preferably 80% or higher, more preferably 90% or higher, and even more preferably 100% of the OH groups, are condensed.

### Step B2

In step B2, specifically, for example, the silsesquioxane compound having an epoxy group obtained in step B1 as the functional group (a) that can introduce a secondary hydroxyl group and a (meth)acryloyloxy group is reacted with a compound having a (meth)acryloyloxy group and the functional group (b) that can produce a secondary hydroxyl group by reaction with the functional group (a) of the silsesquioxane compound.

A specific example of the functional group (b) is carboxyl.

A specific example of the compound having a (meth)acryloyloxy group and the functional group (b) that can produce a secondary hydroxyl group by reaction with the functional group (a) (i.e., epoxy) of the silsesquioxane compound is (meth)acrylic acid.

The reaction conditions in step B2 are not limited. Specifically, the reaction can be carried out in the presence of a catalyst.

Specific examples of the catalyst include tertiary amines such as triethylamine and benzyldimethylamine; quaternary ammonium salts such as tetramethylammonium chloride, tetraethylammonium bromide, and tetrabutylammonium bromide; secondary amine salts such as acetate and formate of diethylamine etc.; alkali metal or alkaline earth metal hydroxides such as sodium hydroxide and calcium hydroxide; alkali metal or alkaline earth metal salts such as sodium acetate and calcium acetate; imidazoles; cyclic nitrogen-containing compounds such as diazabicycloundecene; phosphorus compounds such as triphenylphosphine and tributyiphosphine; and the like. The amount of the catalyst used is not limited, but is specifically, for example, 0.01 to 5 mass % based on the amount of the reaction starting material.

In this reaction, any solvent can be used without limitation, and specifically, for example, the organic solvent used in step B1 may be used.

The reaction temperature is 0 to 200° C., preferably 10 to 200° C., and more preferably 10 to 120° C. Although this reaction can be carried out at any pressure, the pressure range is preferably 0.02 to 0.2 MPa, and more preferably 0.08 to 0.15 MPa.

The silsesquioxane compound of the present invention is produced by the above-described production method.

The silsesquioxane compound of the present invention may have asymmetric carbon, and the configuration (R, S) of the asymmetric carbon may be either R or S.

When not all of the OH groups are condensed in the hydrolysis condensation reaction in step B1, the product obtained by the production method B may contain, other than a silsesquioxane compound having a structure in which all of the Si—OH (hydroxysilyl) groups are subjected to hydrolysis condensation, silsesquioxane compounds having a rudder structure, an incomplete cage structure, and/or a random structure, in which the Si—OH groups remain. The silsesquioxane compound of the present invention obtained by the production method B may contain such compounds having a rudder structure, an incomplete cage structure, and/or a random structure.

### Active Energy Ray-Curable Composition

The active energy ray-curable composition of the present invention comprises the silsesquioxane compound of the present invention and a photoinitiator. Examples of active energy rays include UV light, visible light, x-rays, gamma rays, electron beams, and the like; preferably, visible light and UV light are used.

### Photoinitiator

There is no particular limitation to the usable photoinitiators, as long as they absorb an active energy ray and generate a radical.

Examples of the photoinitiators include benzyl, diacetyl, and like α-diketones; benzoin and like acyloins; benzoin methyl ether, benzoin ethyl ether, benzoin isopropyl ether, and like acyloin ethers; thioxanthone, 2,4-diethylthioxanthone, 2-isopropylthioxanthone, thioxanthone-4-sulfonic acid, and like thioxanthones; benzophenone, 4,4′-bis(dimethylamino)benzophenone, 4,4′-bis(diethylamino)benzophenone, and like benzophenones; Michler's ketones; acetophenone, 2-(4-toluenesulfonyloxy)-2-phenylacetophenone, p-dimethylaminoacetophenone, α,α′-dimethoxyacetoxybenzophenone, 2,2′-dimethoxy-2-phenylacetophenone, p-methoxyacetophenone, 2-methyl[4-(methylthio)phenyl]-2-morpholino-1-propanone, 2-benzyl-2-dimethylamino-1-(4-morpholinophenyl)-butan-1-one, α-isohydroxy isobutylphenone, α,α′-dichloro-4-phenoxyacetophenone, 1-hydroxy-cyclohexyl-phenylketone, and like acetophenones; 2,4,6-trimethylbenzoyldiphenylphosphine oxide, bis(acyl)phosphine oxide, and like acylphosphine oxides; anthraquinone, 1,4-naphthoquinone, and like quinones; phenacyl chloride, trihalomethylphenylsulfone, tris(trihalomethyl)-s-triazine, and like halogenated compounds; di-t-butyl peroxide, and like peroxides; etc. These may be used singly, or in a combination of two or more.

Examples of commercially available photoinitiators include Irgacure 184, Irgacure 261, Irgacure 500, Irgacure 651, Irgacure 907, and Irgacure CGI 1700 (trade names, products of Ciba Specialty Chemicals); Darocur 1173, Darocur 1116, Darocur 2959, Darocur 1664, Darocur 4043 (trade names, products of Merck Japan Ltd.); Kayacure-MBP, Kayacure-DETX-S, Kayacure-DMBI, Kayacure-EPA, Kayacure-OA (trade names, products of Nippon Kayaku Co., Ltd.); Vicure 10, Vicure 55 (trade names, products of Stauffer Co., Ltd.); Trigonal P1 (trade name, a product of Akzo Co., Ltd.); Sandoray 1000 (trade name, a product of Sandoz Co., Ltd.); Deap (trade name, a product of APJOHN Co., Ltd.); Quantacure PDO, Quantacure ITX, Quantacure EPD (trade names, products of Ward Blenkinsop Co., Ltd.); etc.

From the viewpoint of photocurability, the photoinitiator preferably comprises at least one of thioxanthones, acetophenones and acyl phosphine oxides, or a mixture thereof. Of these, the photoinitiator more preferably comprises a mixture of acetophenones and acyl phosphine oxides.

The amount of the photoinitiator used is not particularly limited, but is preferably within a range of from 0.5 to 10 parts by mass, and more preferably within a range of from 1 to 5 parts by mass, per 100 parts by mass of the total amount of nonvolatile components in the active energy ray-curable composition. The lower limit of the above range is important to improve the curability with an active energy ray, and the upper limit is important in terms of the cost and deep-section curability.

### Polymerizable Unsaturated Compound

The active energy ray-curable composition of the present invention may further comprise a polymerizable unsaturated compound. There is no particular limitation to the usable polymerizable unsaturated compounds, as long as the polymerizable unsaturated compound is a compound other than the silsesquioxane compound of the present invention and has at least one polymerizable unsaturated double bond in its chemical structure.

Examples of the polymerizable unsaturated compounds include esterified products of a monohydric alcohol and (meth)acrylic acid, and the like. Specific examples thereof include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, neopentyl (meth) acrylate, cyclohexyl (meth) acrylate, tetrahydrofurfuryl (meth)acrylate, isobornyl (meth)acrylate, phenyl (meth)acrylate, benzyl (meth)acrylate, M-acryloyloxyethyl hexahydrophthalimide, and the like. Examples of the polymerizable unsaturated compounds further include esterified products of a polyhydric alcohol and (meth)acrylic acid. Specific examples thereof include ethylene glycol di(meth)acrylate, diethylene glycol di(meth)acrylate, triethylene glycol di(meth)acrylate, tetraethylene glycol di(meth)acrylate, 1,3-butanediol di(meth)acrylate, 1,4-butanediol di(meth)acrylate, 1,9-nonanediol di(meth)acrylate, glycerin di(meth)acrylate, trimethylolpropane di(meth)acrylate, pentaerythritol di(meth)acrylate, neopentyl glycol di(meth)acrylate, 1,6-hexanediol di(meth)acrylate, pentaerythritol di(meth)acrylate, bisphenol A ethylene oxide-modified di(meth)acrylate, and like di(meth)acrylate compounds; glycerin tri(meth)acrylate, trimethylolpropane tri(meth)acrylate, trimethylolpropane propylene oxide-modified tri(meth)acrylate, trimethylolpropane ethylene oxide-modified tri(meth)acrylate, pentaerythritol tri(meth)acrylate, ε-caprolactone-modified tris (acryloxyethyl)isocyanurate, and like tri(meth)acrylate compounds; pentaerythritol tetra(meth)acrylate, and like tetra(meth)acrylate compounds; and dipentaerythritol penta(meth)acrylate, dipentaerythritol hexa(meth)acrylate, etc. Examples thereof further include urethane (meth)acrylate resins, epoxy (meth)acrylate resins, polyester (meth)acrylate resins, and the like. Urethane (meth)acrylate resins can be obtained by, for example, using a polyisocyanate compound, a hydroxyalkyl (meth)acrylate, and a polyol compound as starting materials, and carrying out a reaction in such a manner that a hydroxyl group is used in an equimolar or excess amount based on the amount of isocyanate. The polymerizable unsaturated compounds can be used singly, or in a combination of two or more.

Examples of the “polymerizable unsaturated compound having high polarity” include those having an imide structure, a hydroxyl group, an isocyanurate ring, etc. Specific examples thereof include N-acryloyloxyethyl hexahydrophthalimide, glycerin di(meth)acrylate, trimethylolpropane di(meth)acrylate, pentaerythritol di(meth)acrylate, pentaerythritol tri(meth)acrylate, ε-caprolactone-modified tris(acryloxyethyl)isocyanurate, pentaerythritol tetra(meth)acrylate, dipentaerythritol penta(meth)acrylate, urethane (meth)acrylate resin, and epoxy (meth)acrylate resin.

When used, the amount of the polymerizable unsaturated compound is not particularly limited. However, from the viewpoint of the properties of the formed coating film, the amount of the polymerizable unsaturated compound used is preferably 0.1 to 1,000 parts by mass, and more preferably 20 to 200 parts by mass, per 100 parts by mass of nonvolatile components of the silsesquioxane compound of the present invention.

The active energy ray-curable composition of the present invention may optionally comprise various additives. Examples of the additives include sensitizers, UV absorbers, light stabilizers, polymerization inhibitors, antioxidants, defoaming agents, surface control agents, plasticizers, coloring agents, and the like.

The active energy ray-curable composition of the present invention may optionally comprise inorganic nanoparticles. Examples of the inorganic nanoparticles include clay, silica (colloidal silica, fumed silica, and amorphous silica), silica sol, metal, metal oxide (e.g., titanium dioxide, zirconium oxide, caesium oxide, aluminum oxide, zinc oxide, cerium oxide, yttrium oxide, and antimony oxide), metal nitride, metal carbide, metal sulfide, metal fluoride, metal silicate, metal boride, metal carbonate, zeolite, etc. The mean particle diameter of the inorganic nanoparticles is preferably 1 to 1,000 nm, more preferably 1 to 100 nm, and even more preferably 2 to 50 nm. The mean particle diameter can be measured by a dynamic light-scattering method, a method using electron micrographs, or like method.

The active energy ray-curable composition of the present invention may be diluted with a solvent as required. Examples of the solvents used for dilution include acetone, methyl ethyl ketone, methyl isobutyl ketone, and like ketones; ethyl acetate, butyl acetate, methyl benzoate, methyl propionate, and like esters; tetrahydrofuran, dioxane, dimethoxyethane, and like ethers; ethylene glycol monomethyl ether, ethylene glycol monoethyl ether, diethylene glycol monomethyl ether, propylene glycol monomethyl ether acetate, 3-methoxybutyl acetate, and like glycol ethers; and aromatic hydrocarbons and aliphatic hydrocarbons, etc. These can suitably be used in a combination for the purpose of adjusting viscosity, application properties, etc.

There is no particular limitation to the nonvolatile components in the active energy ray-curable composition of the present invention. For example, the amount is preferably 20 to 100 mass %, and more preferably 25 to 70 mass %. The above-mentioned amount range is important in terms of the smoothness of the formed coating film, and to shorten the drying time.

There is no particular limitation to methods for applying the active energy ray-curable composition of the present invention to the surface of a substrate. Examples thereof include roller coating, roll coater coating, spin coater coating, curtain roll coater coating, slit coater coating, spray coating, electrostatic coating, dip coating, silk printing, spin coating, and the like.

The substrates are not particularly limited. Specific examples of the substrates include metal, ceramic, glass, plastic, wood, and the like. These substrates may have coating films thereon.

When a coating film is formed from the above-mentioned active energy ray-curable composition, drying may be performed if required. The drying method is not particularly limited insofar as the solvents contained therein can be removed. For example, the drying may be performed at a temperature of 20 to 100° C. for 3 to 20 minutes.

The film thickness of the coating film is arbitrarily adjusted according to the purpose. For example, the film thickness is preferably 1 to 100 μm, and more preferably 1 to 20 μm. If the film thickness is greater than the lower limit of the above-mentioned range, the coating film will have excellent smoothness and appearance. If the film thickness is below the upper limit of the above-mentioned range, the coating film will have excellent curability and cracking resistance.

After the active energy ray-curable composition is applied to the surface of a substrate, an active energy ray is irradiated to form a cured coating film. There is no particular limitation to the radiation source and radiation dose of the active energy-ray irradiation. Examples of radiation sources of an active energy ray include an extra-high pressure mercury-vapor lamp, a high pressure mercury-vapor lamp, a middle pressure mercury-vapor lamp, a low-pressure mercury-vapor lamp, a chemical lamp, a carbon arc light, a xenon light, a metal halide light, a fluorescent light, a tungsten light, sunlight, and the like. The radiation dose is, for example, preferably within a range of from 5 to 20,000 J/m², and more preferably within a range of from 100 to 10,000 J/m².

The active energy-ray irradiation can be performed in open air, or in an inert gas atmosphere. Examples of inert gases include nitrogen, carbon dioxide, and the like. From the viewpoint of curability, the active energy-ray irradiation is preferably performed in an inert gas atmosphere.

### EXAMPLES

The present invention is described in more detail below with reference to Examples. The phrases “parts” and “%” mean “parts by mass” and “% by mass”, respectively, unless otherwise stated. The structural analysis and measurement in the Examples were conducted using, in addition to the analysis equipment described above in the specification, the following analysis equipment and measuring method.

### ²⁹Si-NMR Analysis and ¹H-NMR Analysis

Equipment: FT-NMR EX-400, manufactured by JEOL

Solvent: CDCl₃

Internal standard substance: tetramethylsilane

FT-IR analysis

Equipment: FT/IR-610, manufactured by JASCO Corporation

### SP Value Measurement Method

The SP value used in the Examples is a solubility parameter that can be measured by a simple measurement method (turbidimetric titration), and the value is calculated according to the following formula suggested by K. W. Suh and J. M. Corbett (see the description of Journal of Applied Polymer Science, 12, 2359, 1968).

Formula: SP=(√Vml·δH+√Vmh·δD)/(√Vml+√Vmh)

In turbidimetric titration, n-hexane is gradually added into a solution of 0.5 g of a sample dissolved in 10 ml of acetone, and the titration amount H (ml) at the turbidity point is read. Similarly, deionized water is added into an acetone solution, and the titration amount D (ml) at the turbidity point is read. These values are applied to the following formulae to determine Vml, Vmh, δH, and δD. The molecular volume (mol/ml) of each solvent is as follows: acetone: 74.4, n-hexane: 130.3, and deionized water: 18. SP of each solvent is as follows: acetone: 9.75, n-hexane: 7.24, and deionized water: 23.43.

Vml=74.4×130.3/((1−VH)×130.3+VH×74.4)

Vmh=74.4×18/((1−VD)×18+VD×74.4)

VH=H/(10+H)

VD=D/(10+D)

δH=9.75×10/(10+H)+7.24×H/(10+H)

δD=9.75×10/(10+D)+23.43×D/(10+D)

### Example 1

Glycidyl POSS Cage Mixture (400 parts; trade name, manufactured by Hybrid Plastics) and 600 parts of butyl acetate were placed in a separable flask equipped with a reflux condenser, a thermometer, an air-introducing pipe, and a stirrer, and dissolved by stirring at 60° C. Acrylic acid (190 parts), 1.5 parts of methoquinone, and 10 parts of tetrabutylammonium bromide were added thereto, and the mixture was reacted at 100° C. for 4 hours while blowing dry air thereinto, thereby obtaining a product (P1) solution having a nonvolatile content of 50%.

The Glycidyl POSS Cage Mixture used as a starting material was 3-glycidoxypropyl group-containing cage-type polysilsesquioxane having a weight average molecular weight of 1800 and an epoxy equivalent of 168 g/eq.

As a result of ²⁹Si-NMR analysis of the product (P1), only a peak derived from a T3 structure in which all of three oxygen atoms bonded to Si were bonded to other Si was observed at around −70 ppm, while T1 and T2 structures indicating the presence of a hydroxysilyl group were not confirmed.

Further, as a result of ¹H-NMR analysis of the product (P1), a peak derived from a methylene group bound to Si was observed at 0.6 ppm. In addition, peaks derived from the carbon-carbon unsaturated bond of an acryloyloxy group were observed at 5.9 ppm, 6.1 ppm, and 6.4 ppm. Calculations based on the intensity ratio of these peaks showed that the molar ratio of the carbon-carbon unsaturated bond of the acryloyloxy group to the methylene group bonded to Si was 1.07. (The molar ratio was over 1.00 because an excessive amount of acrylic acid was added to promote the addition reaction of acrylic acid.) No peak belonging to an epoxy group was observed. The epoxy equivalent was 10,000 g/eq or more.

Moreover, as a result of FT-IR analysis of the product (P1), a broad peak belonging to a hydroxyl group, which was not observed in the Glycidyl POSS Cage Mixture (starting material), was observed at around 3500 cm⁻¹.

Furthermore, as a result of GPC analysis of the product (P1), the weight average molecular weight was 2,700.

The results of the ²⁹Si-NMR, ¹H-NMR, FT-IR, and GPC analyses of the product (P1) demonstrated that the product (P1) was a silsesquioxane compound having a weight average molecular weight of 2,700 and comprising a silsesquioxane compound represented by the formula: (R⁸SiO_{3/2})₁₀, wherein R⁸ is a structure represented by the formula (IX):

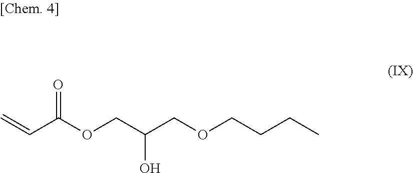

m is 10, n is 0, p is 0, and m+n+p is 10, in an amount of 55% or more (55 to 60%; the other components are estimated to have a rudder structure, a random structure, and other cage structures). The SP value of the obtained silsesquioxane compound was 12.3.

### Example 2

Epoxycyclohexyl POSS Cage Mixture (400 parts; trade name, manufactured by Hybrid Plastics) and 600 parts of propylene glycol monomethyl ether acetate were placed in a separable flask equipped with a reflux condenser, a thermometer, an air-introducing pipe, and a stirrer, and dissolved by stirring at 60° C. Methacrylic acid (210 parts), 1.5 parts of methoquinone, and 10 parts of tetrabutylammonium bromide were added thereto, and the mixture was reacted at 100° C. for 48 hours while blowing dry air thereinto, thereby obtaining a product (P2) solution having a nonvolatile content of 50%.

The Epoxycyclohexyl POSS Cage Mixture used as a starting material was 2-(3,4-epoxycyclohexyl)ethyl group-containing cage-type polysilsesquioxane having a weight average molecular weight of 2,200 and an epoxy equivalent of 178 g/eq.

As a result of ²⁹Si-NMR analysis of the product (P2), only a peak derived from a T3 structure in which all of three oxygen atoms bonded to Si were bonded to other Si was observed at about −70 ppm, while T1 or T2 structures indicating the presence of a hydroxysilyl group were not confirmed.

Further, as a result of ¹H-NMR analysis of the product (P2), a peak derived from a methylene group bonded to Si was observed at 0.6 ppm. In addition, peaks derived from the carbon-carbon unsaturated bond of a methacryloyloxy group were observed at 5.5 ppm and 6.1 ppm. Calculations based on the intensity ratio of these peaks showed that the molar ratio of the carbon-carbon unsaturated bond of the methacryloyloxy group to the methylene group bonded to Si was 1.05. (The molar ratio was over 1.00 because an excessive amount of methacrylic acid was added to promote the addition reaction of methacrylic acid.) No peak belonging to an epoxy group was observed. The epoxy equivalent was 10,000 g/eq or more.

Moreover, as a result of FT-IR analysis of the product (P2), a broad peak belonging to a hydroxyl group, which was not observed in the Epoxycyclohexyl POSS Cage Mixture (starting material), was observed at about 3500 cm⁻¹.

Furthermore, as a result of GPC analysis of the product (P2), the weight average molecular weight was 3,500.

The results of the ²⁹Si-NMR, ¹H-NMR, FT-IR, and GPC analyses of the product (P2) demonstrated that the product (P2) was a silsesquioxane compound having a weight average molecular weight of 3,500 and comprising a mixture of silsesquioxane compounds represented by the formulae: (R⁹SiO_{3/2})₈, (R⁹SiO_{3/2})₁₀, and (R⁹SiO_{3/2})₁₂, wherein R⁹ is a structure represented by the formula (X):

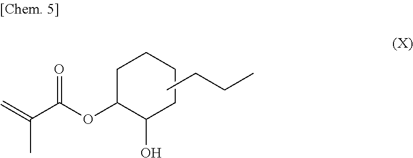

in the formula (R⁹SiO_{3/2})₈, m is 8, n is 0, p is 0, and m+n+p is 8; in the formula (R⁹SiO_{3/2})₁₀, m is 10, n is 0, p is 0, and m+n+p is 10; and in the formula (R⁹SiO_{3/2})₁₂, m is 12, n is 0, p is 0, and m+n+p is 12; in an amount of 55% or more (55 to 60%; the other components are estimated to have a rudder structure, a random structure, and other cage structures.) The SP value of the obtained silsesquioxane compound was 12.1.

### Example 3

KBM-403 (108 parts; trade name, manufactured by Shin-Etsu Chemical Co., Ltd.; 3-glycidoxypropyltrimethoxysilane), 35 parts of acrylic acid, 1.5 parts of hydroquinone, and 5 parts of tetrabutylammonium bromide were placed in a separable flask equipped with a reflux condenser, a thermometer, and a stirrer, and the mixture was reacted at 100° C. for 24 hours while blowing dry air thereinto, thereby obtaining a product (P3). Toluene (300 parts), 30 parts of a tetrabutylammonium hydroxide 40% methanol solution, and 12 parts of deionized water were placed in a separable flask equipped with a reflux condenser, a thermometer, and a stirrer, and the resulting mixture was cooled in an ice bath to 2° C. A mixed solution of 300 parts of tetrahydrofuran and 143 parts of the product (P3) was added thereto, and the mixture was reacted at 20° C. for 24 hours. The obtained product was added to vigorously stirred deionized water for coagulation. The resulting precipitate was collected by decantation and washed with deionized water. After drying under reduced pressure for 24 hours, the resultant was dissolved in 100 parts of propylene glycol monomethyl ether acetate, thereby obtaining a product (P4) solution having a nonvolatile content of 50%.

As a result of ²⁹Si-NMR analysis of the product (P4), a peak derived from a T3 structure in which all of three oxygen atoms bonded to Si were bonded to other Si was observed at about −70 ppm, and a peak derived from a T2 structure having a hydroxysilyl group was observed at −59 ppm. The integrated intensity ratio of these peaks was 90/10.

Further, as a result of ¹H-NMR analysis of the product (P4), a peak derived from a methylene group bonded to Si was observed at 0.6 ppm. In addition, peaks derived from the carbon-carbon unsaturated bond of an acryloyloxy group were observed at 5.9 ppm, 6.1 ppm, and 6.4 ppm. Calculations based on the intensity ratio of these peaks showed that the molar ratio of the carbon-carbon unsaturated bond of the acryloyloxy group to the methylene group bonded to Si was 1.06. (The ratio was over 1.00 because an excessive amount of acrylic acid was added to promote the addition reaction of acrylic acid.) No peak belonging to an epoxy group was observed. The epoxy equivalent was 10,000 g/eq or more.

Moreover, as a result of FT-IR analysis of the product (P4), a broad peak belonging to a hydroxyl group was observed at around 3500 am⁻¹.

Furthermore, as a result of GPC analysis of the product (P4), the weight average molecular weight was 2,000.

The results of the “Si-NMR, ¹H-NMR, FT-IR, and GPC analyses of the product (P4) demonstrated that the product (P4) was a silsesquioxane compound having a weight average molecular weight of 2,000 and comprising a silsesquioxane compound represented by the formula: (R¹⁰SiO_{3/2})₈, wherein R¹⁰ is a structure represented by the formula (IX):

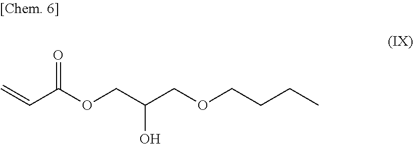

m is 8, n is 0, p is 0, and m+n+p is 8, in an amount of 75% or more (75 to 80%; the other components are estimated to have a rudder structure, a random structure, and other cage structures). The SP value of the obtained silsesquioxane compound was 12.5.

### Example 4

The product (P3) was synthesized in the same manner as in Example 3. The product (P3) (80 parts), 61 parts of KBM-5103 (trade name, manufactured by Shin-Etsu Chemical Co., Ltd.; 3-acryloyloxy propyltrimethoxysilane), 1300 parts of toluene, 1.0 parts of methoquinone, and 30 parts of deionized water were placed in a separable flask equipped with a reflux condenser, a thermometer, and a stirrer, and the mixture was heated to 80° C. while stirring and bubbling dry air thereinto. After stirring for 6 hours, the reflux condenser was removed, and a water separator was attached instead. The temperature was increased to the boiling point of toluene, and water was collected while toluene was refluxed. After this operation was continued for 10 hours, it was confirmed that the distillation of water was completed, and the reaction was terminated. The toluene was distilled off by vacuum distillation, and 105 parts of ethylene glycol monobutyl ether was added thereto, thereby obtaining a product (P5) solution having a nonvolatile content of 50%.

As a result of ²⁹S1-NMR analysis of the product (P5), a peak derived from a T3 structure in which all of three oxygen atoms bonded to Si were bonded to other Si was observed at around −70 ppm, and a peak derived from a T2 structure having a hydroxysilyl group was observed at −59 ppm. The integrated intensity ratio of these peaks was 90/10.

Further, as a result of ¹H-NMR analysis of the product (P5), a peak derived from a methylene group bonded to Si was observed at 0.6 ppm. In addition, peaks derived from the carbon-carbon unsaturated bond of an acryloyloxy group were observed at 5.9 ppm, 6.1 ppm, and 6.4 ppm. Calculations based on the intensity ratio of these peaks showed that the molar ratio of the carbon-carbon unsaturated bond of the acryloyloxy group to the methylene group bonded to Si was 1.02. No peak belonging to an epoxy group was observed. The epoxy equivalent was 10,000 g/eq or more.

Moreover, as a result of FT-IR analysis of the product (P5), a broad peak belonging to a hydroxyl group was observed at around 3500 cm⁻¹.

Furthermore, as a result of GPC analysis of the product (P5), the weight average molecular weight was 3,000.

The results of the ²⁹Si-NMR, ¹H-NMR, FT-IR, and GPC analyses of the product (P5) demonstrated that the product (P5) was a silsesquioxane compound having a weight average molecular weight of 3,000 and comprising a silsesquioxane compound represented by the formula: (R¹¹SiO_{3/2})₅(R¹²SiO_{3/2})₅, wherein R¹¹ is a structure represented by the formula (IX):

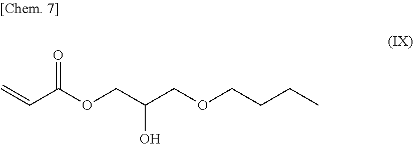

R¹² is a structure represented by the formula (XI):

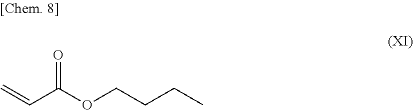

m is 5, n is 0, p is 5, and m+n+p is 10, in an amount of 55% or more (55 to 60%; the other components are estimated to have a rudder structure, a random structure, and other cage structures). The SP value of the obtained silsesquioxane compound was 10.8.

### Example 5

KBM-403 (565 parts), 2,260 parts of 2-propanol, 2.0 parts of tetrabutylammonium fluoride, and 65 parts of deionized water were placed in a separable flask equipped with a reflux condenser, a thermometer, and a stirrer. The mixture was heated to 60° C. by a mantle heater while stirring under nitrogen flow. After reaction at 60° C. for 10 hours, the water, methanol, and 2-propanol were removed by vacuum distillation. Then, 600 parts of propylene glycol monomethyl ether acetate was added thereto, thereby obtaining a product (P6) solution having a nonvolatile content of 40%.

Subsequently, 1,000 parts of the product (P6) solution having a nonvolatile content of 40%, 190 parts of acrylic acid, 1.5 parts of methoquinone, and 10 parts of tetrabutylammonium bromide were placed in a separable flask equipped with a reflux condenser, a thermometer, and a stirrer. The mixture was reacted at 100° C. for 24 hours while blowing dry air thereinto, thereby obtaining a product (P7) solution having a nonvolatile content of 50%.

As a result of ²⁹Si-NMR analysis of the product (P6), a peak derived from a T3 structure in which all of three oxygen atoms bonded to Si were bonded to other Si was observed at around −70 ppm. The integrated intensity ratio of the peak was 90% or more, confirming that the obtained silsesquioxane had a high proportion of T3 structures. In addition, a slight peak derived from a T2 structure in which two of three oxygen atoms bonded to Si were bonded to other Si, and the other oxygen atom was an oxygen atom constituting a hydroxysilyl group was observed at around −59 ppm.

Further, as a result of ¹H-NMR analysis of the product (P6), a peak derived from a methylene group bonded to Si was observed at 0.6 ppm, and peaks derived from an epoxy group were observed at 2.6 ppm, 2.8 ppm, and 3.1 ppm. The molar ratio of the epoxy group to Si determined from the ratio of these peaks was 1.00.

Moreover, as a result of FT-IR analysis of the product (P6), absorptions belonging to an Si—O—Si bond were observed at around 1,100 cm⁻¹ and 1,050 cm⁻¹. However, almost no absorption belonging to the hydroxysilyl group was observed at around 3,500 cm⁻¹. An absorption belonging to the epoxy group was observed at around 910 cm⁻¹. The epoxy equivalent of the product (P6) was 168 g/eq.

Furthermore, as a result of gel permeation chromatograph (GPC) analysis of the product (P6), peaks each having a polystyrene equivalent molecular weight of 2,800, 2,000, or 1,200 were observed. Among these, the largest and sharpest peak having a molecular weight of 1,200 was estimated to belong to an octamer [(RSiO_{3/2})₈], and the proportion of this component was 70 mass % or more of the whole. The weight average molecular weight of the product (P6) was 1,750.

The results of the ²⁹Si-NMR, ¹H-NMR, FT-IR, and GPC analyses of the product (P6) demonstrated that the product (P6) was a silsesquioxane compound having a weight average molecular weight of 1,750 and comprising 70 mass % or more of a silsesquioxane compound represented by the formula: (R¹³SiO_{3/2})₈, wherein R¹³ is a 3-glycidoxypropyl group. The product (P6) also contained small amounts of components having a rudder structure and an imperfect cage structure.

Subsequently, as a result of ²⁹Si-NMR analysis of the product (P7), only a peak belonging to the T3 structure was observed at around −70 ppm.

Further, as a result of ¹H-NMR analysis of the product (P7), a peak derived from a methylene group bonded to Si was observed at 0.6 ppm. In addition, peaks derived from the carbon-carbon unsaturated bond of an acryloyloxy group were observed at 5.9 ppm, 6.1 ppm, and 6.4 ppm. Calculations based on the intensity ratio of these peaks showed that the molar ratio of the carbon-carbon unsaturated bond of the acryloyloxy group to the methylene group bonded to Si was 1.07. (The molar ratio was over 1.00 because an excessive amount of acrylic acid was added to promote the addition reaction of acrylic acid.) The peak derived from the epoxy group that was observed in the analysis of the product (P6) disappeared. The epoxy equivalent was 10,000 g/eq or more.

Moreover, as a result of FT-IR analysis of the product (P7), a broad peak belonging to a hydroxyl group, which was not observed in the analysis of the product (P6), was observed at around 3500 cm⁻¹.

Furthermore, as a result of GPC analysis of the product (P7), the weight average molecular weight was 2,600.

The results of the ²⁹Si-NMR, ¹H-NMR, FT-IR, and GPC analyses of the product (P7) demonstrated that the product (P7) was a silsesquioxane compound having a weight average molecular weight of 2,600 and comprising a silsesquioxane compound represented by the formula: (R¹⁴SiO_{3/2})₈, wherein R¹⁴ is a structure represented by the formula (IX):

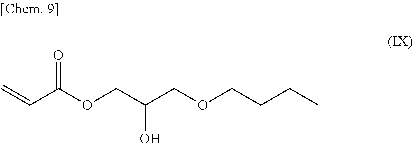

m is 8, n is 0, p is 0, and m+n+p is 8, in an amount of 70 mass % or more (70 to 75%; the other components are estimated to have a rudder structure, a random structure, and other cage structures). The SP value of the obtained silsesquioxane compound was 12.3.

The results of Examples 1 to 5 are summarized in Tables 1 and 2.

TABLE 1

| | Ex. 1 | Ex. 2 | Ex. 3 | Ex. 4 | Ex. 5 |
|---|---|---|---|---|---|
| Whether the product is a | Mixture | Mixture | Mixture | Mixture | Mixture |
| compound having a single | | | | | |
| composition or a mixture. | | | | | |
| Main component of mixture | (i) (R⁸SiO_{3/2})₁₀ | (i) (R⁹SiO_{3/2})₈, | (i) (R¹⁰SiO_{3/2})₈ | (i) | (i) (R¹⁴SiO_{3/2})₈ |
| (described in specification) | | (ii) (R⁹SiO_{3/2})₁₀, | | (R¹¹SiO_{3/2})₅(R¹²SiO_{3/2})₅ | |
| | | (iii) (R⁹SiO_{3/2})₁₂ | | | |
| m + n + p and m, n, and p in | (i) m + n + p = 10, | (i) m + n + p = 8, and | (i) m + n + p = 8, | (i) m + n + p = 10, and | (i) m + n + p = 8, and |
| main component of mixture | and m = 10, n = 0, | m = 8, n = 0, p = 0 | and m = 8, n = 0, | m = 5, n = 0, p = 5 | m = 8, n = 0, p = 0 |
| | p = 0 | (ii) m + n + p = 10, and | p = 0 | | |
| | | m = 10, n = 0, p = 0 | | | |
| | | (iii) m + n + p = 12, and | | | |
| | | m = 12, n = 0, p = 0 | | | |
| Abundance of main component | 55 mass % or | (i) + (ii) + (iii) is | 75 mass % or | 55 mass % or more | 70 mass % or more |
| in mixture | more (55-60%) | 55 mass % or more | more (75-80%) | (55-60%) | (70-75%) |
| | | (55-60%) | | | |
| Weight average molecular | 2700 | 3500 | 2000 | 3000 | 2700 |
| weight (Mw) of mixture | | | | | |

| | | |
|---|---|---|
| Reason for n = 0 | In ¹H-NMR analysis, | Separately shown |
| (identification of absence | the ratio of the acryloyloxy group to the methylene group bonded to Si is about 1.0; and | in Table 2 |
| of epoxy) | there is no peak that indicates the presence of an epoxy group. | |
| | The epoxy equivalent is 10,000 g/eq or more (which means that there are | |
| | almost no epoxy groups). | |
| Reason for p = 0 | Not mixed | |
| Identification of m in main | Identification of n and p, and molecular weight of GPC peak | |
| component | | |
| Identification of m + n + p in | Molecular weight of GPC peak | |
| main component | | |
| Identification of abundance | GPC area | |
| of main component | | |

TABLE 2
Example 5

| | | P6 | | | P7 |
|---|---|---|---|---|---|
| | Whether the product is a | Mixture | | Whether the product is a | Mixture |
| | compound having a single | | | compound having a single | |
| | composition or a mixture. | | | composition or a mixture. | |
| | Main component of mixture | (i) (R¹³SiO_{3/2})₈ | | Main component of mixture | (i) (R¹⁴SiO_{3/2})₈ |
| | (described in specification) | | | (described in specification) | |
| | m + n + p, and m, n, and p in | (i) m + n + p = 8, and m = 0, | | m + n + p, and m, n, and p in | (i) m + n + p = 8, and m = 8, |
| | main component of mixture | n = 8, p = 0 | | main component of mixture | n = 0, p = 0 |
| | Abundance of main | 70 mass % or more | | Abundance of main | 70 mass % or more (70-75%) |
| | component in mixture | | | component in mixture | |
| | Weight average molecular | 1750 | | Weight average molecular | 2600 |
| | weight (Mw) of mixture | | | weight (Mw) of mixture | |
| Identi- | Identification of presence of | In ¹H-NMR analysis, | Identi- | Reason for n = 0 | In ¹H-NMR analysis, |
| fication | epoxy | the ratio of the epoxy | fication | (identification of absence of | the ratio of the acryloyloxy |
| | | group to the methylene group | | epoxy) | group to the methylene group |
| | | bonded to Si is about 1.0. | | | bonded to Si is about 1.0; and |
| | | The epoxy equivalent is | | | there is no peak indicating |
| | | 168 g/eq (theoretically, there are | | | the presence of an epoxy group. |
| | | no side reactions by which the | | | The epoxy equivalent is |
| | | epoxy group disappears.) | | | 10000 g/eq or more (which means |
| | | | | | that there are almost no epoxy |
| | | | | | groups) |
| | Reason for p = 0 | Not mixed | | Reason for p = 0 | Not mixed |
| | Reason for m = 0 | Acrylic acids etc., are not | | | |
| | | mixed. | | | |
| | Reason for n = 8 in main | Identification of n and p, and | | Reason for m = 8 in main | Starting material: P6, n = 0; |
| | component | molecular weight of GPC peak | | component | and molecular weight of GPC peak |
| | Identification of m + n + p in | Molecular weight of GPC peak | | Identification of m + n + p in | Molecular weight of GPC peak |
| | main component | | | main component | |
| | Identification of abundance | GPC area | | Identification of abundance | GPC area |
| | of main component | | | of main component | |

Since the main component of each of the silsesquioxanes produced in Examples has a cage structure, when only the main component is referred to, m+n+p is expressed by an integer (e.g., 8, 10, or 12). Whether the structure of the main component is T8, T10, T12, or another structure can be determined by the molecular weight of the GPC peak. The abundance of the main component in the mixture can be determined from the GPC area.

### Comparative Example 1

Toluene (300 parts), 30 parts of tetrabutylammonium hydroxide 40% methanol solution, and 12 parts of deionized water were placed in a separable flask equipped with a reflux condenser, a thermometer, and a stirrer, and the resulting mixture was cooled in an ice bath to 2° C. After 300 parts of tetrahydrofuran was added thereto for dilution, 110 parts of KBM-5103 was added and reacted at 20° C. for 24 hours.

The resulting product was put in deionized water for coagulation, and the precipitate was filtered by suction and washed with deionized water. The precipitate was then frozen in a freezer at −20° C. After freeze-drying for 24 hours, the precipitate was dissolved in 100 parts of propylene glycol monomethyl ether acetate, thereby obtaining a product (P8) solution having a nonvolatile content of 50%.

As a result of ²⁹Si-NMR analysis of the product (P8), a peak derived from a T3 structure in which all of three oxygen atoms bound to Si were bound to other Si was observed at around 70 ppm, and a peak derived from a T2 structure having a hydroxysilyl group was observed at 59 ppm. The integrated intensity ratio of these peaks was 90/10.

Further, as a result of ¹H-NMR analysis of the product (P8), a peak derived from a methylene group bonded to Si was observed at 0.6 ppm. In addition, peaks derived from the carbon-carbon unsaturated bond of an acryloyloxy group were observed at 5.9 ppm, 6.1 ppm, and 6.4 ppm. Calculations based on the intensity ratio of these peaks showed that the molar ratio of the carbon-carbon unsaturated bond of the acryloyloxy group to the methylene group bonded to Si was 1.00.

Moreover, as a result of GPC analysis of the product (P8), the weight average molecular weight was 1,500.

The results of the ²⁹Si-NMR, ¹H-NMR, and GPC analyses of the product (P8) demonstrated that the product (P8) was a silsesquioxane compound having a weight average molecular weight of 1,500 and comprising a silsesquioxane compound represented by the formula: (R¹⁵SiO_{3/2})₈, wherein R¹⁵ is a structure represented by the following formula (XI):

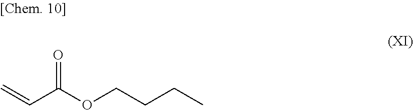

in an amount of 80% or more (80 to 85%; the other components are estimated to have a rudder structure, a random structure, and other cage structures). The SP value of the obtained silsesquioxane compound was 9.5.

### Example 6

The product (P1) solution having a nonvolatile content of 50% obtained in Example 1 and a polymerizable unsaturated compound (A1), described later, were mixed so that the mass ratio of the product (P1) to the polymerizable unsaturated compound (A1) was 1:1, and the mixture was stirred at 40° C. for 24 hours to obtain a mixed solution. The mixed solution was assessed to evaluate the compatibility of the product (P1) obtained in Example 1 with the polymerizable unsaturated compound in a solution state. The dissolved state of the mixed solution was visually observed, and evaluated according to the following criteria. Table 1 shows the evaluation results.

Additionally, the product (P1) was mixed with each of polymerizable unsaturated compounds (A2) to (A8), described later, to obtain mixed solutions in the same manner as described above. Then, the compatibility of each mixed solution was evaluated according to the same criteria as above. Table 1 shows the evaluation results.

### Determination of Compatibility

A: Homogeneous, transparent; good compatibility

B: Slightly cloudy or flickers when shaken; poor compatibility

C: Obviously cloudy, or at least one of separation, aggregation, sedimentation, and gelation was observed; bad compatibility

### Polymerizable Unsaturated Compound

A1: HDDA (trade name, manufactured by Daicel-Cytec Company, Ltd.; 1,6-hexanediol diacrylate)

A2: Aronix M-140 (trade name, manufactured by Toagosei Co., Ltd.; N-acryloyloxyethyl hexahydrophthalimide)

A3: Aronix M-325 (trade name, manufactured by Toagosei Co., Ltd.; ε-caprolactone-modified tris(acryloxyethyl)isocyanurate)

A4: Trimethylolpropane diacrylate

A5: Pentaerythritol diacrylate

A6: Pentaerythritol triacrylate

A7: Aronix M-403 (trade name, manufactured by Toagosei Co., Ltd.; dipentaerythritol penta- and hexa-acrylate)

A8: Aronix M-1200 (trade name, manufactured by Toagosei Co., Ltd.; bifunctional urethane acrylate oligomer)

### Examples 7 to 10 and Comparative Example 2

Mixed solutions of each of the products (P2, P4, P5, P7, and P8) obtained in Examples 2 to 5 and Comparative Example 1 and each of the polymerizable unsaturated compounds were prepared in the same manner as in Example 6, and the compatibility of each product with each polymerizable unsaturated compound in a solution state was evaluated. Table 3 shows the evaluation results.

TABLE 3

| | | Polymerizable unsaturated compound | | | | | | | |
|---|---|---|---|---|---|---|---|---|---|
| | | A1 | A2 | A3 | A4 | A5 | A6 | A7 | A8 |
| Ex. 6 | Product (P1) | A | A | A | A | A | A | A | A |
| Ex. 7 | Product (P2) | A | A | A | A | A | A | A | A |
| Ex. 8 | Product (P4) | A | A | A | A | A | A | A | A |
| Ex. 9 | Product (P5) | A | A | A | A | A | A | A | A |
| Ex. 10 | Product (P7) | A | A | A | A | A | A | A | A |
| Comp. | Product (P8) | A | B | C | B | B | B | B | C |
| Ex. 2 | | | | | | | | | |

### Example 11

Using active energy ray-curable compositions comprising the silsesquioxane compounds of the present invention, the compatibility of each product with each of the polymerizable unsaturated compounds was evaluated. The test procedure is described below.

The product (P1) solution having a nonvolatile content of 50% (100 parts) obtained in Example 1, 50 parts of the polymerizable unsaturated compound (A1), 3.0 parts of 1-hydroxy-cyclohexyl-phenyl-ketone (photoinitiator), and 0.5 parts of 2,4,6-trimethylbenzoyl-diphenyl-phosphine oxide (photoinitiator) were mixed. The mixture was diluted with ethyl acetate to a nonvolatile content of 30%, followed by stirring, thereby preparing an active energy ray-curable composition.

Then, the active energy ray-curable composition was applied on an intermediate plate (Note 1) to a film thickness of 10 inn (when dried) using an applicator, and dried at 80° C. for 10 minutes to remove the solvent. Subsequently, using a high-pressure mercury vapor lamp (80 W/cm), the coating film was cured by irradiation with UV light (peak top wavelength: 365 nm) at a radiation dose of 2,000 mJ/cm². The appearance of the cured coating film was visually observed, and the dissolved state was evaluated according to the following criteria. Table 4 shows the evaluation results.

Additionally, using the same formulation as above except that each of the polymerizable unsaturated compounds (A2) to (A8) was used in place of the polymerizable unsaturated compound (A1), active energy ray-curable compositions each comprising one of the polymerizable unsaturated compounds (A2) to (A8) were prepared. Then, coating films cured under the same conditions as above were prepared. The coating films were visually observed, and the dissolved state was evaluated according to the following criteria. Table 4 shows the evaluation results.

(Note 1) Intermediate plate: ELECRON GT-10 (trade name, manufactured by Kansai Paint Co., Ltd.; a cationic electrodeposition coating composition) was applied by electrodeposition to a cold rolled steel plate (0.8×150×70 mm) treated using Palbond #3020 (trade name, manufactured by Nihon Parkerizing Co., Ltd.; a zinc phosphate treating agent) to a film thickness of 20 μm, and baked and dried at 170° C. for 30 minutes to form an electrodeposition coating film. The electrodeposition coating film was spray-coated with WP-300 (trade name, manufactured by Kansai Paint Co., Ltd.; an aqueous intermediate coating composition) to a cured film thickness of 25 μm, and baked and dried in an electric hot air dryer at 140° C. for 30 minutes to prepare an intermediate plate.

### Determination of Compatibility

A: Homogeneous, transparent; good compatibility

B: Slightly cloudy; poor compatibility

C: Obviously cloudy, or at least one of aggregation, seeding, and crawling was observed; bad compatibility

### Examples 12 to 15 and Comparative Example 3

Active energy ray-curable compositions were prepared in the same manner as in Example 11 except that each of the product solutions (P2, P4, P5, P7, and P8) obtained in Examples 2 to 5 and Comparative Example 1 was used in place of the product (P1) solution having a nonvolatile content of 50%. Subsequently, the active energy ray-curable compositions were cured under the same conditions as in Example 11 to form coating films, and the compatibility of each product with each of the polymerizable unsaturated compounds was evaluated. Table 4 shows the evaluation results.

TABLE 4

| | | Polymerizable unsaturated compound | | | | | | | |
|---|---|---|---|---|---|---|---|---|---|
| | | A1 | A2 | A3 | A4 | A5 | A6 | A7 | A8 |
| Ex. 11 | Product (P1) | A | A | A | A | A | A | A | A |
| Ex. 12 | Product (P2) | A | A | A | A | A | A | A | A |
| Ex. 13 | Product (P4) | A | A | A | A | A | A | A | A |
| Ex. 14 | Product (P5) | A | A | A | A | A | A | A | A |
| Ex. 15 | Product (P7) | A | A | A | A | A | A | A | A |
| Comp. | Product (P8) | A | C | C | C | C | C | C | C |
| Ex. 3 | | | | | | | | | |

### Examples 16 to 22

Active energy ray-curable compositions were prepared in the same manner as the method for preparing active energy ray-curable compositions and the method for preparing cured coating films in Example 11 using the formulations shown in Table 5. Then, cured coating films with a film thickness of 10 μm (when dried) were formed on intermediate plates (Note 1) to obtain test panels. Each of the obtained test panels was evaluated for scratch resistance and weather resistance. Table 5 shows the evaluation results.

### Scratch Resistance

Each of the coating films was rubbed against commercially available steel wool (#0000), and the coating film was visually observed and evaluated according to the following criteria.

A: No scratching, cracking, or peeling, or slight scratching but satisfactory from a practical standpoint

B: Scratched

C: Cracked, peeled, significantly scratched, etc.

### Weather Resistance

Each of the obtained test panels was subjected to a 1000-hour test using a Sunshine Weather-O-Meter. Then, the coating film of the panel was visually observed and evaluated according to the following criteria.

A: No abnormalities, or slightly blistered, discolored, change in gloss, peeled, etc., but satisfactory from a practical standpoint

B: Blistered, discolored, change in gloss, peeled, etc.

C: Remarkably blistered, discolored, change in gloss, peeled, etc.

TABLE 5

| | | | Ex. 16 | Ex. 17 | Ex. 18 | Ex. 19 | Ex. 20 | Ex. 21 | Ex. 22 |
|---|---|---|---|---|---|---|---|---|---|
| Active | Product | P1 | 50 | 50 | 50 | | | | |
| energy ray- | | P2 | | | | 50 | | | |
| curable | | P4 | | | | | 50 | | |
| composition | | P5 | | | | | | 50 | |
| | | P7 | | | | | | | 50 |
| | Polymerizable | A2 | 50 | | | 50 | | | 50 |
| | unsaturated | A3 | | 50 | | | 50 | | |
| | compound | A8 | | | 50 | | | 50 | |

| | | | | | | | |
|---|---|---|---|---|---|---|---|
| 1-hydroxy- | 3.0 | 3.0 | 3.0 | 3.0 | 3.0 | 3.0 | 3.0 |
| cyclohexyl- | | | | | | | |
| phenyl-ketone | | | | | | | |
| 2,4,6- | 0.5 | 0.5 | 0.5 | 0.5 | 0.5 | 0.5 | 0.5 |
| trimethylbenzoyl- | | | | | | | |
| diphenyl- | | | | | | | |
| phosphine oxide | | | | | | | |

| | | | | | | | |
|---|---|---|---|---|---|---|---|
| Scratch resistance | A | A | A | A | A | A | A |
| Weather resistance | A | A | A | A | A | A | A |

The numbers in the formulations denote nonvolatile contents.

1. A silsesquioxane compound comprising organic groups each directly bonded to a silicon atom of the compound, at least one of the organic groups being an organic group having one or more secondary hydroxyl groups and one (meth)acryloyloxy group.

2. The silsesquioxane compound according to claim 1 represented by the formula (I):
(R¹SiO_{3/2})ₘ(R²SiO_{3/2})ₙ(R³SiO_{3/2})ₚ (I)
wherein R¹ is an organic group having one or more secondary hydroxyl groups and one (meth)acryloyloxy group; R² is an organic group having an epoxy group; R³ is a hydrogen atom, a C₁₋₃₀ substituted or unsubstituted monovalent hydrocarbon group, an organic group having a vinyl group, or a (meth)acryloyloxy alkyl group in which the alkyl group has 1 to 3 carbon atoms; each of R¹, R², and R³ may be the same or different; m is an integer of 1 or more; n is an integer of 0 or more; p is an integer of 0 or more; and m+n+p is an integer of 4 or more.

3. The silsesquioxane compound according to claim 1, which has a weight average molecular weight of 1,000 to 100,000.

4. The silsesquioxane compound according to claim 2, wherein in the formula (I), R¹ is an organic group represented by the formula (II) or (III): 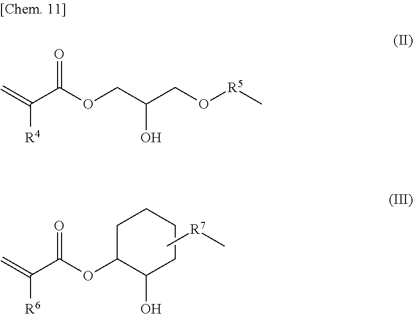
in the formula (II), R⁴ is a hydrogen atom or a methyl group, and R⁵ is a C₁₋₁₀ divalent hydrocarbon group; in the formula (III), R⁶ is a hydrogen atom or a methyl group, and R⁷ is a C₁₋₁₀ divalent hydrocarbon group.

5. An active energy ray-curable composition comprising the silsesquioxane compound according to claim 1, and a photoinitiator.

6. The active energy ray-curable composition according to claim 5, further comprising a polymerizable unsaturated compound.

7. The active energy ray-curable composition according to claim 6, wherein the polymerizable unsaturated compound is selected from the group consisting of an esterified product of an monohydric alcohol and (meth)acrylic acid, an esterified product of a polyhydric alcohol and (meth)acrylic acid, a urethane (meth)acrylate resin, an epoxy (meth)acrylate resin, and a polyester (meth)acrylate resin.

8. The active energy ray-curable composition according to claim 6, wherein the esterified product of a monohydric alcohol and (meth)acrylic acid is selected from the group consisting of methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, neopentyl (meth)acrylate, cyclohexyl (meth)acrylate, tetrahydrofurfuryl (meth)acrylate, isobornyl (meth)acrylate, phenyl (meth)acrylate, benzyl (meth)acrylate, and N-acryloyloxyethyl hexahydrophthalimide; and
the esterified product of a polyhydric alcohol and (meth)acrylic acid is selected from the group consisting of di(meth)acrylate compounds such as ethylene glycol di(meth)acrylate, diethylene glycol di(meth)acrylate, triethylene glycol di(meth)acrylate, tetraethylene glycol di(meth)acrylate, 1,3-butanediol di(meth)acrylate, 1,4-butanediol di(meth)acrylate, 1,9-nonanediol di(meth)acrylate, glycerin di(meth)acrylate, trimethylolpropane di(meth)acrylate, pentaerythritol di(meth)acrylate, neopentyl glycol di(meth)acrylate, 1,6-hexanediol di(meth)acrylate, pentaerythritol di(meth)acrylate, and bisphenol A ethylene oxide-modified di(meth)acrylate; tri(meth)acrylate compounds such as glycerin tri(meth)acrylate, trimethylolpropane tri(meth)acrylate, trimethylolpropane propylene oxide-modified tri(meth)acrylate, trimethylolpropane ethylene oxide-modified tri(meth)acrylate, pentaerythritol tri(meth)acrylate, and ε-caprolactone-modified tris(acryloxyethyl) isocyanurate;
tetra(meth)acrylate compounds such as pentaerythritol tetra(meth)acrylate; dipentaerythritol penta(meth)acrylate, and dipentaerythritol hexa(meth)acrylate.

9. The silsesquioxane compound according to claim 2, which has a weight average molecular weight of 1,000 to 100,000.

10. The silsesquioxane compound according to claim 3, wherein in the formula (I), R¹ is an organic group represented by the formula (II) or (III): 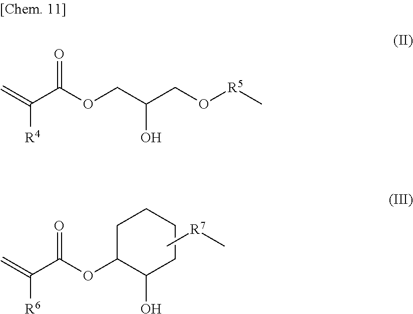
in the formula (II), R⁴ is a hydrogen atom or a methyl group, and R⁵ is a C₁₋₁₀ divalent hydrocarbon group; in the formula (III), R⁶ is a hydrogen atom or a methyl group, and R⁷ is a C₁₋₁₀ divalent hydrocarbon group.

11. An active energy ray-curable composition comprising the silsesquioxane compound according to claim 2, and a photoinitiator.

12. An active energy ray-curable composition comprising the silsesquioxane compound according to claim 3, and a photoinitiator.

13. An active energy ray-curable composition comprising the silsesquioxane compound according to claim 4, and a photoinitiator.
